(19) United States
(12) Patent Application Publication
(10) Pub. No.: US 2004/0119586 A1
(43) Pub. Date: Jun. 24, 2004

(54) Identification of a computing device

(75) Inventor: Stephen Paul Rowles, Bassett (GB)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 10/693,339

(22) Filed: Oct. 24, 2003

(30) Foreign Application Priority Data
Dec. 19, 2002 (GB) 0229679.6

(51) Int. Cl. G08B 25/00

(52) U.S. Cl. 340/524; 340/691.1

(57) ABSTRACT

A method and system for identifying the physical location of computing devices. Each computing device has an identifying device that is activated when a user wishes to locate that device. The identifying device may be attached to or an integrated part of the computing device. The identifying device alerts the user by emitting light, sound, odor, or projecting a physical object. The identifying device may also alert the user with a pattern unique to the computing device. Once the user is alerted by the identifying device the user can physically locate the computing device.

### CROSS REFERENCE TO RELATED APPLICATIONS

This application claims priority to an application entitled “Identification of a Computing Device” filed in The Patent Office of the United Kingdom on Dec. 19, 2002, and assigned application number 0229679.6, the contents of which are hereby incorporated by reference.

### FIELD OF THE INVENTION

This invention relates generally to identifying the physical location of machines. More specifically this invention relates to identifying the physical location of computing devices.

### DESCRIPTION OF THE RELATED ART

Typically computing devices such as main frame computers, server banks, data storage systems, and related computer devices are stored with many other like devices in one large room. This makes it difficult to physically locate any particular computing device.

These computing devices are typically tagged or labeled with a unique identifier. Most of these tags or labels are very small and located at awkward positions on the computing device. While these tags and labels are appropriate for inventory purposes they are not very helpful in physically locating a particular computing device among other computer devices.

Another method used to locate computing devices in such circumstances is to chart the physical location of each device. Keeping such a chart current becomes burdensome, however, because in these circumstances the devices get moved frequently requiring a continuous updating of the location chart.

Thus, there is an existing need in the industry for a more effective way of physically locating computing devices.

### SUMMARY OF THE INVENTION

It is therefore one object of the present invention to provide a method of identifying the physical location of machines.

It is yet another object of the present invention to provide a method of identifying the physical location of computing devices.

The foregoing objects are achieved as is now described. A unique identifying mechanism is added to each piece of computing. Alternatively, each computing device will utilize an identifying mechanism already existing within the device itself. This identifying mechanism can be a light, a colored light, a series of lights, a sound emitting device, a smell-emitting device, a physically projecting device, or any other uniquely identifying device as may be contemplated by one skilled in the art.

These identifying devices will all be connected to a control console by a connection that could be Internet, wireless Internet, wired, or any such connection as may be contemplated by one skilled in the art.

One skilled in the art would know that the identifying device could very well be integrated into the computing device, and therefore the connection to the processor could be made indirectly via a connection from the control console to the computing device and from the computing device to the integrated identifying device.

A user wishing to physically locate a particular computing device would enter that computing device at the control console, which would then send the message to the identifying device and activate the device. In this manner the user would quickly and efficiently physically locate the desired computing device.

### BRIEF DESCRIPTION OF THE DRAWINGS

The novel features believed to be characteristic of the invention are set forth in the appended claims. The present invention itself, however, as well as a preferred mode of use, further objects and advantages thereof, will best be understood by reference to the following detailed description of a preferred embodiment when read in conjunction with the accompanying drawings wherein:

FIG. 1 is a component diagram of a preferred embodiment of the present invention;

FIG. 2 is a schematic representation of the software running on both a control console and a server to be located, in accordance with one embodiment of the present invention; and

FIG. 3 is a schematic representation of the software running on both a control console and a server to be located, in accordance with another embodiment of the present invention.

### DETAILED DESCRIPTION OF PREFERRED EMBODIMENTS

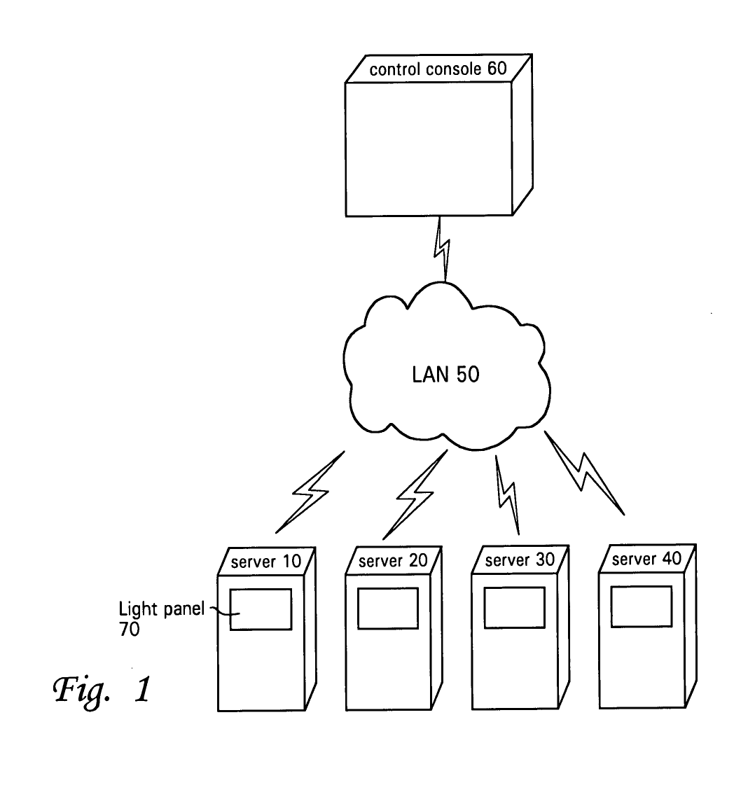

With reference to FIG. 1, a control console 60 is connected via a Local Area Network (LAN) 50 to a room of servers 10-40. Each server has at least one additional light 70 fitted to it (preferably in a highly visible place such as the front of the server box).

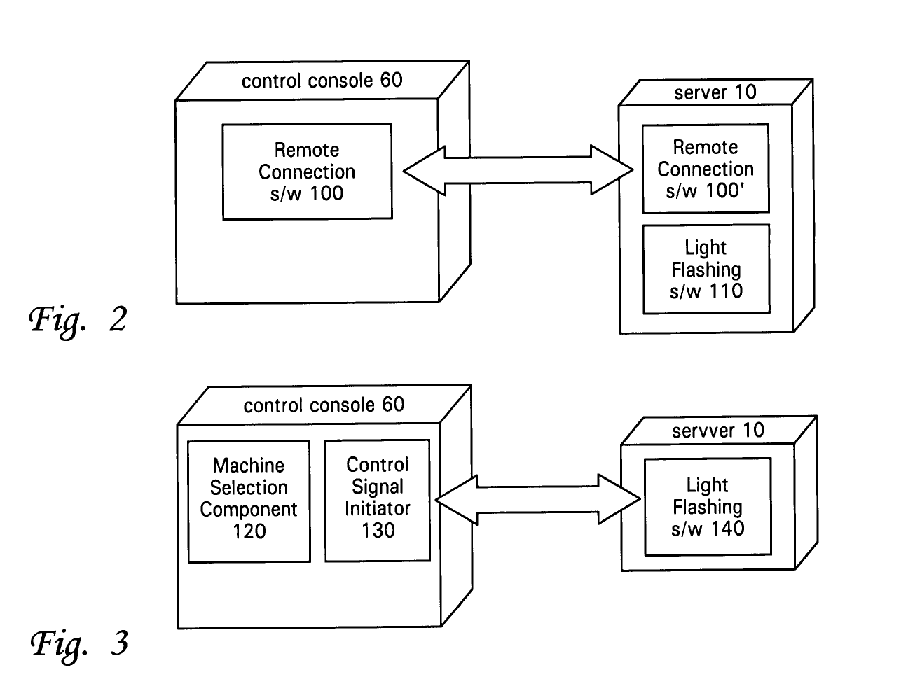

FIG. 2 dipicts one example of software running on both a control console 60 and a server to be located 10. Console 60 runs remote connection software such as telnet, NetMeeting, or any other connection software as may be contemplated by one skilled in the art. Using this software, it is possible to specify the name of a machine to which a user wishes to connect and thus set up a remote connection between the two machines over which data can be sent. The user of control console 60 can then access light flashing software 110 running on server 10 via this connection. Dependent upon the software being run at both ends, the user may use either a command prompt or a graphical user interface (GUI) to control the light flashing software 110. Such software 110 is used to cause a light on, for example, the front of the server 10 to turn on/flash etc.

FIG. 3 dipicts a second example of software running on both the control consoled 60 and a server to be physically located 10. Control Console 60 comprises a software component 120 via which the server to be located can be selected. Via this software a machine can be selected and a control signal initiator 130 transmits a control signal to the selected machine, server 10. The control signal is received by light flashing software 140 executing on the server. The signal received causes a light, for example, on the front of the server box to turn on or flash.

It will be appreciated that the control console 60 could be a dedicated machine. In an alternative embodiment, any of servers 10 to 40 could be used to locate another of servers 10 to 40.

Once initiated by software, light hardware optionally has a means for remembering a light pattern configuration and would keep displaying this configuration even in the event of a software crash. Such a means could, for example, be a non-volatile memory.

A second command could be used to switch the light off once the server has been located or a time limit could be used (i.e. on expiry of this limit, the light could be switched off).

One skilled in the art would know that the user may wish to physically locate several servers without having to return to the control console. Alternatively, several users may wish to simultaneously physically locate different machines. Thus each server may be fitted with a panel of lights (e.g. high intensity multicolor light emitting diodes). For example, six lights on each panel would provide 64 unique combinations when considering the binary values of on and off. This matched with different patters and colors would allow a large number of machines to be easily and separately identified. Users would however preferably have a point of reference from which they could discover particulars of the indicator means for any server they wished to physically locate (e.g. the light flash pattern). In one embodiment each user has a different light pattern associated with them, such that each user can easily locate servers that they are responsible for.

One skilled in the art would know that the use of colors might be particularly important since servers already display light(s) when processing data. A distinct color (e.g. blue or red) for the light(s) of the invention could be used to distinguish these lights from the data processing lights (typically yellow or green). Alternatively, the lights could be one and the same. In other words no additional hardware is required, with the same lights being used to indicate data processing and to announce the server's presence to a user.

With either the embodiment of FIG. 2 or 3, each server may be preprogrammed with one or more patterns of lights each in response to a control signal. Alternatively, a remote request/the control signal may include the light pattern for server 10 to display.

It will also be appreciated that instead of lights, any human-perceptible indicator means could be used to announce a server to a user. For example, each server could emit a different sound or even smell. Alternatively, some servers could flash lights, whilst others could emit sounds/smells. Physical projection (e.g. a flag) could also be used.

One skilled in the art would know that the light(s) or other indicator means do not have to form an integral part of the server. Alternatively, this could be implemented as a separate piece of hardware connected (e.g. by cable or wiring) to each server.

It will further be appreciated that the invention is applicable to any computing device (not just servers) with sufficient processing power to invoke light flashing/indicator means software.

Upon reference to the foregoing, those skilled in the art will appreciate that the inventors herein have described a system whereby the physical location of computing devices can be easily identified.

While the invention has been particularly shown and described with reference to a preferred embodiment it will be understood by those skilled in the art that various changes in form and detail may be made therein without departing from the spirit and scope of the invention.

What is claimed is:

1. A computing device enabling a user to identify the physical location of said computing device from among a plurality of computing devices comprising:
an indicator means;
a remote computing device;
a means for receiving a request from said remote computing device for activating said indicator means; and
a means responsive to said request for activating said indicator means.

2. The computing device of claim 1, wherein said indicator means further comprises at least one light.

3. The computing device of claim 1 wherein said indicator means further comprises means for displaying a light pattern.

4. The computing device of claim 1, further comprising at least one colored light.

5. The computing device of claim 1, further comprising a pre-programmed indicator means pattern for display in response to said request.

6. The computing device of claim 1, further comprising means for receiving with said request an indicator means pattern to emit.

7. The computing device of claim 1, wherein said indicator means comprises means for emitting an audible signal.

8. The computing device of claim 7, further comprising a pre-programmed indicator means pattern to emit in response to said request.

9. The computing device of claim 7, further comprising means for receiving with said request an audible signal to emit.

10. The computing device of claim 1, wherein said indicator means comprises means for emitting a smellable odor.

11. The computing device of claim 10, further comprising a pre-programmed indicator means pattern to emit in response to said request.

12. The computing device of claim 1, wherein said indicator means comprises means for projecting a physical object.

13. The computing device of claim 12, further comprising a pre-programmed indicator means pattern to emit in response to said request.

14. The computing device of claim 1, wherein said indicator means is a metal housing with a plurality of attached lights.

15. The computing device of claim 1, wherein said indicator means comprises means for remembering an indicator means pattern.

16. An apparatus for physically locating a remote computing device enabling identification of said computing device from among a plurality of computing devices, said apparatus comprising:
means operable to receive a user selection for selecting said computing device;
means operable to receive a user request for activating indicator means forming part of said computing device; and
means for requesting activation of the indicator means at the remote computing device.

17. A method for physically locating a remote computing device enabling identification of said computing device from among a plurality of computing devices, said method comprising the steps of:
receiving a user selection of said computing device;
receiving a user request for activation of indicator means forming part of said computing device; and requesting activation of the indicator means at the remote computing device

18. A method for controlling indicator means enabling a user to identify the physical location of a computing device from among a plurality of computing devices, said method comprising the step of:
responsive to a user-initiated request from a remote computing device and activating said indicator means.

19. A computer program product enabling a user to identify the physical location of a computing device from among a plurality of computing devices, said computer program product comprising:
instruction means operable to receive a user selection for selecting said computing device;
instruction means operable to receive a user request for activating indicator means forming part of said computing device; and
instruction means for requesting activation of the indicator means at the remote computing device.

20. A computer program product enabling a user to identify the physical location of a computing device from among a plurality of computing devices, said computer program product comprising instructions for:
receiving a user selection of said computing device;
receiving a user request for activation of indicator means forming part of said computing device; and
requesting activation of the indicator means at the remote computing device.

21. A computer program product enabling a user to identify the location of a computing device from among a plurality of computing devices, said program computer product comprising instructions for:
responsive to a user-initiated request from a remote computing device and activating said indicator means.
